(19) United States
(12) Patent Application Publication
(10) Pub. No.: US 2009/0083782 A1
(43) Pub. Date: Mar. 26, 2009

(54) SYSTEMS AND METHODS FOR MANAGING PARENTAL CONTROL SETTINGS IN MULTIPLE ENTERTAINMENT DEVICES

(75) Inventor: JOHN ANTHONY CARD, II, DENVER, CO (US)

Correspondence Address: INGRASSIA FISHER & LORENZ, P.C. (ES), 7010 E. COCHISE ROAD, SCOTTSDALE, AZ, 85253, US

(73) Assignee: ECHOSTAR TECHNOLOGIES CORPORATION, Englewood, CO (US)

(21) Appl. No.: 11/860,290

(22) Filed: Sep. 24, 2007

(51) Int. Cl. H04N 7/16

(52) U.S. Cl. 725/25

(57) ABSTRACT

Parental control settings may be managed between multiple entertainment devices, such as digital televisions (DTVs). A system includes a first entertainment device and a second entertainment device. The first entertainment device is configured to selectively block content based on a first set of parental control settings, and the second entertainment device configured to selectively block content based on a second set of parental control settings. The first entertainment device is configured to transmit the first set of parental control settings to the second entertainment device, and the second entertainment device is configured to receive the first set of parental control settings and to modify the second set of parental control settings such that they are substantially equivalent to the first set of parental control settings.

### TECHNICAL FIELD

The embodiments described herein generally relate to parental controls, and more particularly relate to managing parental control settings in multiple entertainment devices.

### BACKGROUND

It is not uncommon for a household to include a large number of televisions, digital video recorders, set-top boxes, MP3 players, and other such entertainment devices distributed throughout the home. Furthermore, such environments increasingly include some form of data communication network, such as a WiFi network, which may facilitate communication among two or more of the entertainment devices.

At the same time, there has been increasing concern regarding the nature of programming and other content available to children using such entertainment devices. This has prompted, for example, the U.S. congress to promulgate certain laws and standards intended to provide technological features (e.g., the “V-chip”) providing parents the option of blocking the display of violent, sexual, or other content that they believe is harmful to their children. As with similar measures in other countries, the V-chip system works by utilizing a set of parental control settings within the television such that content is blocked based upon a content rating system—e.g., the rating system established by the Federal Communications Commission FCC 98-36, which sets forth categories “TV-Y,” “TV-Y7,” “TV-Y7-FV,” “TV-G,” “TV-PG,” “TV-14,” and “TV-MA.”

While a user may configure one television in the house with the desired parental settings (for example, a television in the family room), the remaining televisions (e.g., in one or more bedrooms) may not be similarly configured, and thus provide a method for children to intentionally or unintentionally access inappropriate programming.

Accordingly, it is desirable to provide methods and apparatus for managing parental control settings between multiple entertainment devices. Other desirable features and characteristics of the various embodiments will become apparent from the subsequent detailed description and the appended claims, taken in conjunction with the accompanying drawings and the foregoing technical field and background.

### BRIEF SUMMARY

Methods and apparatus in accordance with various embodiments allow parental control settings to be managed between multiple entertainment devices, such as digital televisions (DTVs). A system in accordance with one embodiment include a first entertainment device and a second entertainment device. The first entertainment device is configured to selectively block content based on a first set of parental control settings, and the second entertainment device configured to selectively block content based on a second set of parental control settings. The first entertainment device is configured to transmit the first set of parental control settings to the second entertainment device, and the second entertainment device is configured to receive the first set of parental control settings and to modify the second set of parental control settings such that they are substantially equivalent to the first set of parental control settings.

A digital television (DTV) in accordance with one embodiment is configured to selectively block content based on a first set of parental control settings stored therein. The DTV is configured to transmit, in response to a first user request, the first set of parental control settings to a second DTV. It is further configured to receive, in response to a second user request, a second set of parental control settings from the second DTV and to modify the second set of parental control settings such that the first set of parental control settings is substantially equivalent to the second set of parental control settings.

In another embodiment, a method of managing parental controls includes providing a first entertainment device, providing a first set of parental control settings associated with the first entertainment device; providing a second entertainment device; transmitting the first set of parental control settings from the first entertainment device to the second entertainment device; and implementing the first set of parental control settings in the second entertainment device.

### BRIEF DESCRIPTION OF THE DRAWINGS

Various embodiments will hereinafter be described in conjunction with the following drawing figures, wherein like numerals denote like elements, and

FIG. 1 schematically depicts an environment with multiple entertainment devices useful in describing the present invention; and

FIG. 2 schematically depicts the communication of parental controls from one entertainment device to a second entertainment device.

### DETAILED DESCRIPTION

The various embodiments described herein generally relate to systems and methods for providing consistent parental control settings or policies in multiple entertainment devices by communicating parental control settings from one device to another. In this regard, the following detailed description is merely exemplary in nature and is not intended to limit the described embodiments or the application and uses of the described embodiments. Similarly, there is no intention to be bound by any expressed or implied theory presented in the preceding technical field, background, brief summary or the following detailed description.

In the interest of conciseness, conventional techniques, structures, and principles known by those skilled in the art may not be described herein, including, for example, those relating to digital television operation, data communication, and the like. For simplicity and clarity of illustration, the drawing figures depict the general structure and/or manner of construction of the various embodiments. Descriptions and details of well-known features and techniques may be omitted to avoid unnecessarily obscuring other features. Elements in the drawings figures are not necessarily drawn to scale, and thus the dimensions of some features may be exaggerated relative to other elements to assist improve understanding of the example embodiments.

Terms of enumeration such as “first,” “second,” “third,” and the like may be used for distinguishing between similar elements and not necessarily for describing a particular spatial or chronological order. These terms, so used, are interchangeable under appropriate circumstances. Unless expressly stated otherwise, “connected” or “connecting” means that one element/node/feature is directly joined to (or directly communicates with) another element/node/feature, but not necessarily mechanically. Likewise, “coupled” or “coupling” means that one element, node, or feature is directly or indirectly joined to (or directly or indirectly communicates with) another element, node, or feature, but not necessarily mechanically. The terms “comprise,” “comprising,” “include,” “have” and any variations thereof are used synonymously to denote non-exclusive inclusion. The terms “left,” right,” “in,” “out,” “front,” “back,” “up,” “down,” and other such directional terms are used to describe relative positions, not necessarily absolute positions in space. The term “exemplary” is used in the sense of “example,” rather than “ideal.”

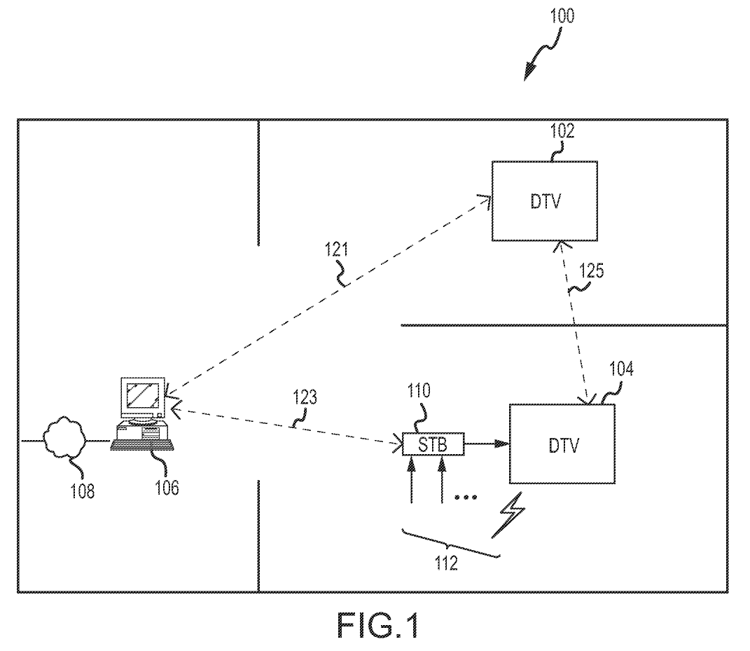

FIG. 1 depicts an example environment 100—in this case, the floorplan of a house—useful in describing the present invention. As shown, environment 100 includes three entertainment devices (or simply “devices”) 102, 104, and 106. In this example, entertainment devices 102 and 104 are illustrated as digital televisions (DTVs), and entertainment device 106 is illustrated as a media center personal computer (or simply “PC”). The term “DTV” may be used herein, without loss of generality, to refer to a particular device.

In this embodiment, DTV 104 is illustrated as coupled to a set-top box (STB) 110, as is known in the art, while DTV 102 is not. Thus, DTV 104 receives its programming from STB 110, which itself receives programming, in various formats, from broadcast signals 112. These broadcast signals may include, for example, HDTV signals, digital cable signals, analog television signals, terrestrial broadcast signals, and the like. DTV 102, as illustrated, receives programming from PC 106 through a suitable network connection. Many other components may typically be included in such an environment 100, including digital video recorders, image processors, audio receivers, surround-sound hardware, etc.

DTV 102, DTV 104, and PC 106 may communicate with each other through any suitable data communication method (designated by dotted lines 121, 123, and 125). Such connections may be wired or wireless. Example wired connections include Ethernet and serial connections. Example wireless connections include WiFi, UPnP, infrared (IR), and the like. Furthermore, the devices may communicate through the television signals themselves. One or more of devices 102, 104, and 106 may be also be coupled to a network 108 (e.g., the Internet and/or a local-area network).

Both DTV 102 and DTV 104 are configured to selectively block content based on a set of parental control settings (or simply “settings”), which are typically stored locally in RAM, in a hard-disk, or in any other suitable memory. Television devices typically allow for on-screen programming of these settings via a “guide” feature, where individual shows, ratings, and/or channels are blocked. A variety of such parental control settings and content rating systems are well known in the art, and need not be described in detail herein. In general, however, such systems work by blocking content based on whether the advisory packets within the broadcast signal itself match one or more of the settings stored within the device.

As mentioned above, the parental control settings programmed into or otherwise provided within DTV 102 may not match those of DTV 104. Thus, it is desirable for these settings to be “reconciled” or otherwise modified such that they are substantially equivalent. In accordance with one embodiment, parental control settings in one device (e.g., DTV 104) is communicated to another (e.g., DTV 102). Reconciliation between DTV 102 and DTV 104 may also include an “unlock” status for one or more devices. Alternatively, one device (e.g., DTV 102) may be re-locked from local STB 110 by a user watching DTV 104.

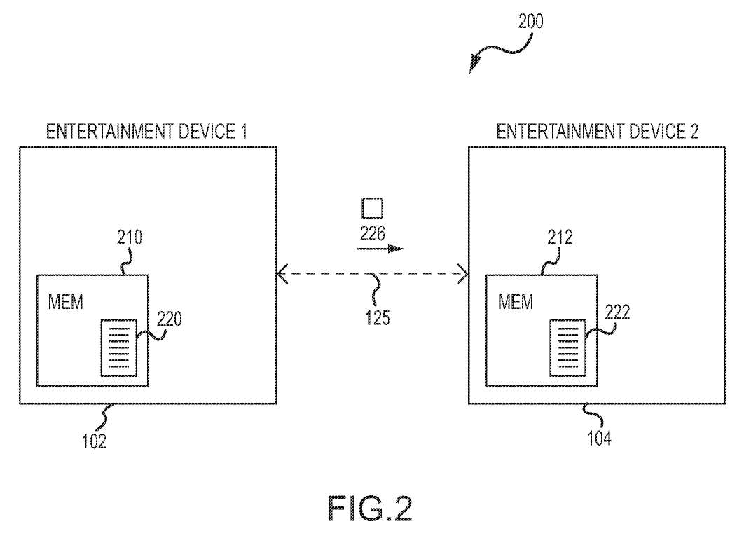

More particularly, referring now to FIG. 2, consider the scenario in which it is desirable to change the parental settings of device 104 such that it more closely matches those of device 102. As shown, devices 102 and 104 each contain a memory (210, 212) and a set of parental control settings stored therein (220, 222). Each device 102, 104 will include numerous other components (not shown) depending upon the nature of the device. For example, in the event that device 102 is a DTV, it will typically include a display screen (e.g., LCD, plasma), a rendered (to create the displayed image), as well as a controller, a v-chip, and various I/O submodules.

Communication is established between the devices through communication link 125, which, as mentioned earlier, may be wired or wireless. The parental control settings 220 is then suitably communicated in a data packet 226 to device 104. This communication may be triggered automatically, or may be initiated by a user. In one embodiment, for example, the user may operate DTV such that a graphical user interface is displayed, allowing the user to initiate the transfer of all or a part of the settings 220. In one embodiment, device 104 periodically advertises its settings to any other device configured to listen to such advertisements.

Data packet 226 may have any suitable format and be communicated through any convenient protocol. For example, packet 226 may include data specifying the advisory status as a whole, or may specify the settings rating-by-rating. The packets may be based on the U.S. FCC rating system (e.g., Consumer Electronics Association standard CEA-766-A), or generalized based on the country of use. In one mode of operation, the user watching device 104 could override the parental control settings in device 102 by copying all or a portion of the settings from device 104 over the network to device 102. Such an override may be enabled a priori by configuration settings in device 102 that prepare it to accept settings from device 104. Alternatively, this function may be enabled by remotely unlocking device 102 before sending new settings. In another embodiment, a user watching device 104 might request the settings from device 102 and copy all or a portion of the settings to device 104 or device 110. In yet another embodiment, before device 110 sends content to device 104, device 110 requests the parental control settings on device 104, receives a response that includes some or all of those settings, and only transmits content that is consistent with the settings on device 104.

Upon receipt of data packet 226, device 104 may modify its own settings 222 within memory 212 such that they are substantially equivalent to settings 220, or may chose to reject all or part of those settings. This decision may be automated, or may be directed by the user in response to a query displayed as part of the graphical user interface. Each device 102 is preferably configured to send as well as receive advertised parental control settings.

Any convenient type of user interface may be used to accomplish the methods set forth above. For example, the salient parameters for parental control understood by device 102 might be presented on device 104, or device 104 might translate those settings into a different form before presenting and settings such parameters.

While at least one exemplary embodiment has been presented in the foregoing detailed description, it should be appreciated that a vast number of variations exist. The foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

What is claimed is:

1. A method for managing parental controls comprising:
providing a first entertainment device;
providing a first set of parental control settings associated with the first entertainment device;
providing a second entertainment device;
transmitting the first set of parental control settings from the first entertainment device to the second entertainment device; and
implementing the first set of parental control settings in the second entertainment device.

2. The method of claim 1, wherein the step of providing a first entertainment device includes providing a digital television (DTV) device.

3. The method of claim 2, wherein the step of providing a first set of parental control settings includes providing information in accordance with a television content rating system.

4. The method of claim 1, wherein providing the second entertainment device includes providing a system selected from the group consisting of a digital television (DTV), a set-top box (STB), a personal computer, and an audio device.

5. The method of claim 1, wherein the transmitting step includes transmitting the first set of parental control settings wirelessly.

6. The method of claim 5, wherein the transmitting step is accomplished via a data communication scheme selected from the group consisting WiFi, UPnP, IR, and RF.

7. The method of claim 1, wherein the transmitting step includes transmitting the first set of parental control settings via a wired connection.

8. The method of claim 7, wherein the transmitting step is accomplished via an Ethernet connection.

9. A system for managing parental controls comprising:
a first entertainment device configured to selectively block content based on a first set of parental control settings; and
a second entertainment device configured to selectively block content based on a second set of parental control settings;
wherein the first entertainment device is configured to transmit the first set of parental control settings to the second entertainment device, and the second entertainment device is configured to receive the first set of parental control settings and to modify the second set of parental control settings such that they are substantially equivalent to the first set of parental control settings.

10. The system of claim 9, wherein the first entertainment device is a digital television (DTV).

11. The system of claim 9, wherein the parental control settings correspond to a television content rating system.

12. The system of claim 9, wherein the second entertainment device is selected from the group consisting of a digital television (DTV), a set-top box (STB), a personal computer, and an audio device.

13. The system of claim 9, wherein the first set of parental control settings is transmitted wirelessly via a data communication scheme selected from the group consisting WiFi, UPnP, IR, and RF.

14. The system of claim 9, wherein the first set of parental control settings is transmitted via an Ethernet connection.

15. The system of claim 9, wherein at least one of the first and second entertainment devices includes a V-chip configured to selectively block the content.

16. The system of claim 9, wherein the first entertainment device is configured to transmit the parental control settings in response to a user request.

17. A digital television (DTV) of the type configured to selectively block content based on a first set of parental control settings stored therein, the DTV configured to:
transmit, in response to a first user request, the first set of parental control settings to a second DTV; and
receive, in response to a second user request, a second set of parental control settings from the second DTV and to modify the second set of parental control settings such that the first set of parental control settings is substantially equivalent to the second set of parental control settings.

18. The DTV of claim 17, further configured to transmit and receive the first and second parental control settings via a wireless connection.

19. The DTV of claim 17, further including a V-chip configured to selectively block the content.

20. The DTV of claim 17, further configured to receive a request for the first set of parental control settings from a set-top box, transmit the first set of parental control settings to the set-top box, and receive the content from the set-top box that is filtered consistent with the first set of parental control settings.
